(19) United States
(12) Patent Application Publication
(10) Pub. No.: US 2024/0145153 A1
(43) Pub. Date: May 2, 2024

(54) INDUCTOR COMPONENT

(71) Applicant: Murata Manufacturing Co., Ltd., Kyoto-fu (JP)

(72) Inventors: Yoshihiro FUJITA, Nagaokakyo-shi (JP); Hiromi MIYOSHI, Nagaokakyo-shi (JP); Tomohiro DOZEN, Nagaokakyo-shi (JP); Hirofumi KABAYAMA, Nagaokakyo-shi (JP)

(73) Assignee: Murata Manufacturing Co., Ltd., Kyoto-fu (JP)

(21) Appl. No.: 18/461,306

(22) Filed: Sep. 5, 2023

(30) Foreign Application Priority Data
Oct. 28, 2022 (JP) 2022-173532

(51) Int. Cl. H01F 27/02; H01F 27/28

(52) U.S. Cl. CPC H01F 27/02; H01F 27/2828

(57) ABSTRACT

An inductor component includes a base body including an insulator, an inductor wire extending inside the base body, extended electrodes connected to the inductor wire, each of the extended electrodes having a portion exposed to outside of the base body, and outer electrodes connected to respective ones of the extended electrodes. The base body, inductor wire, and extended electrodes form a component body. When a first sectional area is defined as an area of a section of the component body taken along a plane parallel to the bottom surface of the component body at an arbitrary position and when a second sectional area is defined as an area of another section of the component body taken along another plane parallel to the bottom surface closer to the bottom surface from the arbitrary position, the second sectional area is equal to or greater than the first sectional area.

### CROSS-REFERENCE TO RELATED APPLICATION

This application claims benefit of priority to Japanese Patent Application No. 2022-173532, filed Oct. 28, 2022, the entire content of which is incorporated herein by reference.

### BACKGROUND

### Technical Field

The present disclosure relates to an inductor component.

### Background Art

Japanese Unexamined Patent Application Publication No. 2017-191923 discloses an inductor component that includes a cuboid-like base body and outer electrodes. The base body has multiple coil layers and two reinforcing layers. Each of the coil layers includes an insulating layer, a coil conductor extending on the insulating layer, and conductive vias piercing through the insulating layer. The coil layers are laminated together. Coil conductors of the adjacent coil layers are connected to each other using the conductive vias. The reinforcing layers are laminated, respectively, on one principal surface of the laminated body of the coil layers and on the other principal surface of the laminated body that is positioned oppositely to the one principal surface. The reinforcing layers are made of a material having a rigidity higher than that of the insulating layer.

### SUMMARY

The inductor component described in Japanese Unexamined Patent Application Publication No. 2017-191923 is mounted on a board with a specific surface of the inductor component facing the board in order to obtain, for example, desired electrical characteristics. However, when the inductor component is packaged in a packing material or when the packaged inductor component is mounted on a board, the electronic component may topple over. In such a case, the inductor component may be mounted on the board with an unintended surface of the inductor component facing the board.

Accordingly, the present disclosure provides an inductor component that includes i) a base body made of an insulator, ii) an inductor wire extending inside the base body, iii) extended electrodes connected to the inductor wire, each one of the extended electrodes having a portion exposed to outside of the base body, and iv) outer electrodes connected to respective ones of the extended electrodes. The base body, the inductor wire, and the extended electrodes form a component body together. The component body has a flat bottom surface and a top surface facing oppositely to the bottom surface. An area of the bottom surface is greater than an area of the top surface. When a first sectional area is defined as an area of a section of the component body that is taken along a plane parallel to the bottom surface at an arbitrary position and when a second sectional area is defined as an area of another section of the component body that is taken along another plane parallel to the bottom surface at a position closer to the bottom surface from the arbitrary position, the second sectional area is equal to or greater than the first sectional area.

With this configuration, the area of the bottom surface is greater than the area of the top surface. Accordingly, the bottom surface has the greater area, and the inductor component is placed on the board with the bottom surface facing downward, which reduces the likelihood of the inductor component toppling over.

The likelihood of the inductor component toppling over is reduced.

### BRIEF DESCRIPTION OF THE DRAWINGS

FIG. 1 is a perspective view illustrating an inductor component;

FIG. 2 is a cross-sectional view illustrating the inductor component of FIG. 1 taken along line 2-2; and

FIG. 3 is a cross-sectional view illustrating the inductor component of FIG. 2 taken along line 3-3.

### DETAILED DESCRIPTION

### Embodiment of Inductor Component

An embodiment of an inductor component will be described with reference to the drawings. Note that elements of the inductor component in the drawings may be enlarged or exaggerated to facilitate better understanding. Dimensional relationships between elements may be illustrated differently in the drawings or from the actual elements.

### Overall Structure of Inductor Component

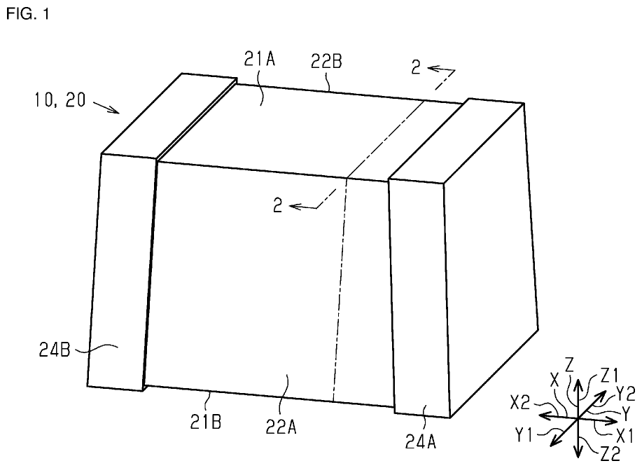

As illustrated in FIG. 1, an inductor component 10 includes a component body 20, a first outer electrode 24A, and a second outer electrode 24B.

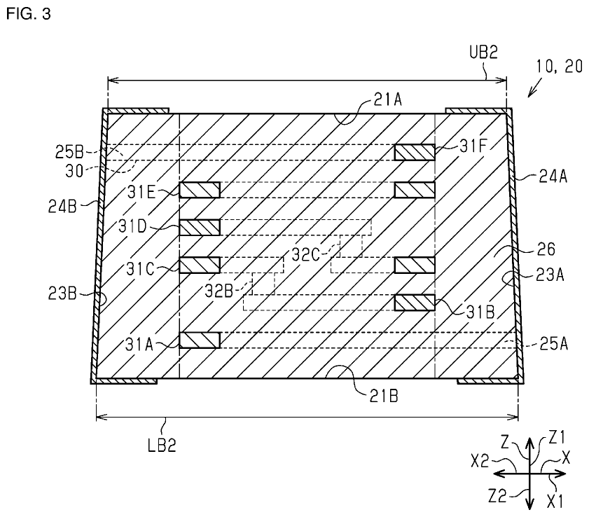

The component body 20 is shaped like a truncated quadrangular pyramid as illustrated in FIG. 1. Accordingly, the component body 20 has six flat outer surfaces. One of the six outer surfaces of the component body 20 is a bottom surface 21B. Note that the bottom surface 21B is the surface that faces a board when the inductor component 10 is mounted on the board. Atop surface 21A is a surface facing oppositely to the bottom surface 21B. The bottom surface 21B and the top surface 21A are substantially parallel to each other. A surface connected to the bottom surface 21B is a first principal surface 22A. A second principal surface 22B of the component body 20 is a surface facing oppositely to the first principal surface 22A. As illustrated in FIG. 3, a first end surface 23A is a surface connected to the bottom surface 21B, the surface being other than the first principal surface 22A and the second principal surface 22B. A second end surface 23B of the component body 20 is a surface facing oppositely to the first end surface 23A. Note that the “flat surface” as used above is allowed to have small irregularities. In other words, when the surfaces of the component body 20 can be recognized as being flat when the component body 20 is viewed as a whole as illustrated in FIG. 1, the component body 20 can be described as having flat surfaces.

As illustrated in FIG. 1, the top surface 21A and the bottom surface 21B are shaped like rectangles. The first principal surface 22A and the second principal surface 22B are shaped like trapezoids. The upper bases of the first principal surface 22A and the second principal surface 22B correspond to the long sides of the top surface 21A. The lower bases of the first principal surface 22A and the second principal surface 22B correspond to the long sides of the bottom surface 21B. In addition, the first end surface 23A and the second end surface 23B are shaped like trapezoids. The upper bases of the first end surface 23A and the second end surface 23B correspond to the short sides of the top surface 21A. The lower bases of the first end surface 23A and the second end surface 23B correspond to the short sides of the bottom surface 21B.

In the following description, a first axis X extends parallel to the long sides of the bottom surface 21B. A second axis Y extends parallel to the short sides of the bottom surface 21B. A third axis Z extends in a direction normal to the bottom surface 21B. Of the directions parallel to the first axis X, a direction in which the first end surface 23A faces is a first positive direction X1 and a direction extending oppositely to the first positive direction X1 is a first negative direction X2. Of the directions parallel to the second axis Y, a direction in which the first principal surface 22A faces is a second positive direction Y1 and a direction extending oppositely to the second positive direction Y1 is a second negative direction Y2. Of the directions parallel to the third axis Z, a direction in which the top surface 21A faces is a third positive direction Z1 and a direction extending oppositely to the third positive direction Z1 is a third negative direction Z2.

The first outer electrode 24A is formed on outer surfaces of the component body 20 so as to cover the first end surface 23A entirely and also to cover portions of the first principal surface 22A, the second principal surface 22B, the top surface 21A, and the bottom surface 21B, the portions being positioned closer to the first end surface 23A. In other words, the first outer electrode 24A is an electrode disposed on five surfaces of the component body 20. The first outer electrode 24A is made of a conductive material, such as silver and copper.

The second outer electrode 24B is formed on outer surfaces of the component body 20 so as to cover the second end surface 23B entirely and also to cover portions of the first principal surface 22A, the second principal surface 22B, the top surface 21A, and the bottom surface 21B, the portions being positioned closer to the second end surface 23B. In other words, the second outer electrode 24B is an electrode disposed on five surfaces of the component body 20. The second outer electrode 24B is made of a conductive material, such as silver and copper.

As illustrated in FIG. 3, the component body 20 includes a base body 26, an inductor wire 30, a first extended electrode 25A, and a second extended electrode 25B.

The base body 26 is a portion of the component body 20 from which the inductor wire 30, the first extended electrode 25A, and the second extended electrode 25B are excluded. The base body 26 is shaped like a truncated quadrangular pyramid, which reflects the above-described shape of the component body 20. The material of the base body 26 is a mixture of glass, resin, and non-magnetic insulator particles. For example, the non-magnetic insulator particles are made of alumina. Accordingly, the base body 26 is an insulator.

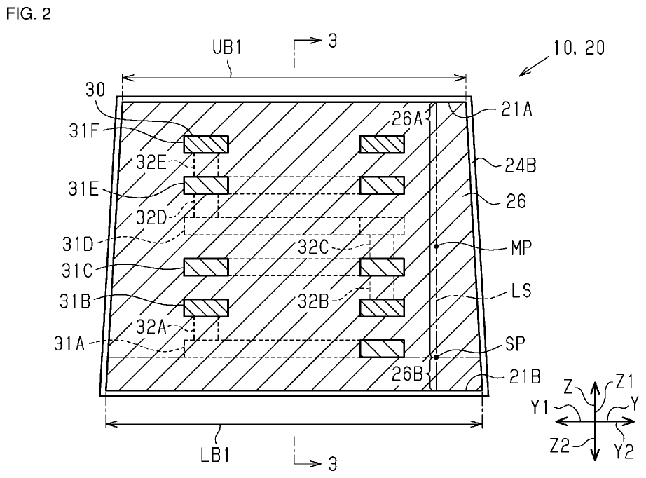

As illustrated in FIGS. 2 and 3, the inductor wire 30 extends inside the component body 20. The inductor wire 30 extends spirally around an axis extending parallel to the third axis Z. The inductor wire 30 includes first to sixth inductor conductors 31A to 31F and first to fifth via conductors 32A to 32E. The first to sixth inductor conductors 31A to 31F are made of a conductive material, such as silver and copper. The first to fifth via conductors 32A to 32E are made of the same conductive material, such as silver and copper, as that of the first to sixth inductor conductors 31A to 31F.

As illustrated in FIGS. 2 and 3, the first inductor conductor 31A extends inside the base body 26 in a direction parallel to the bottom surface 21B. The first inductor conductor 31A extends also in a direction parallel to any one of the sides of the bottom surface 21B.

The second inductor conductor 31B extends inside the base body 26 in a direction parallel to the bottom surface 21B. The second inductor conductor 31B extends also in a direction parallel to any one of the sides of the bottom surface 21B. The second inductor conductor 31B is positioned away from the first inductor conductor 31A in the third positive direction Z1.

The third inductor conductor 31C extends inside the base body 26 in a direction parallel to the bottom surface 21B. The third inductor conductor 31C extends also in a direction parallel to any one of the sides of the bottom surface 21B. The third inductor conductor 31C is positioned away from the second inductor conductor 31B in the third positive direction Z1.

The fourth inductor conductor 31D extends inside the base body 26 in a direction parallel to the bottom surface 21B. The fourth inductor conductor 31D extends also in a direction parallel to any one of the sides of the bottom surface 21B. The fourth inductor conductor 31D is positioned away from the third inductor conductor 31C in the third positive direction Z1.

The fifth inductor conductor 31E extends inside the base body 26 in a direction parallel to the bottom surface 21B. The fifth inductor conductor 31E extends also in a direction parallel to any one of the sides of the bottom surface 21B. The fifth inductor conductor 31E is positioned away from the fourth inductor conductor 31D in the third positive direction Z1.

The sixth inductor conductor 31F extends inside the base body 26 in a direction parallel to the bottom surface 21B. The sixth inductor conductor 31F extends also in a direction parallel to any one of the sides of the bottom surface 21B. The sixth inductor conductor 31F is positioned away from the fifth inductor conductor 31E in the third positive direction Z1.

The first via conductor 32A extends parallel to the third axis Z. The first via conductor 32A connects one end of the first inductor conductor 31A to one end of the second inductor conductor 31B.

The second via conductor 32B extends parallel to the third axis Z. The second via conductor 32B connects one end of the third inductor conductor 31C to the other end of the second inductor conductor 31B, which is the end opposite to the one end to which the first via conductor 32A is connected.

The third via conductor 32C extends parallel to the third axis Z. The third via conductor 32C connects one end of the fourth inductor conductor 31D to the other end of the third inductor conductor 31C, which is the end opposite to the one end to which the second via conductor 32B is connected. The fourth via conductor 32D extends parallel to the third axis Z. The fourth via conductor 32D connects one end of the fifth inductor conductor 31E to the other end of the fourth inductor conductor 31D, which is the end opposite to the one end to which the third via conductor 32C is connected.

The fifth via conductor 32E extends parallel to the third axis Z. The fifth via conductor 32E connects one end of the sixth inductor conductor 31F to the other end of the fifth inductor conductor 31E, which is the end opposite to the one end to which the fourth via conductor 32D is connected.

Accordingly, the first to sixth inductor conductors 31A to 31F and the first to fifth via conductors 32A to 32E form a single inductor wire 30. When the inductor wire 30 is viewed through the component body 20 in a direction parallel to the third axis Z, the inductor wire 30 appears to be a rectangular frame and the first to sixth inductor conductors 31A to 31F are positioned on this rectangular frame. Note that the inductor wire 30 can be integrally formed of the first to sixth inductor conductors 31A to 31F and the first to fifth via conductors 32A to 32E and does not need to have clear boundaries between these conductors.

The first extended electrode 25A and the second extended electrode 25B are portions of the electroconductive member formed inside the base body 26. The first extended electrode 25A and the second extended electrode 25B do not overlap the rectangular frame of the inductor wire 30 when the inductor wire 30 is viewed through the component body 20 in a direction parallel to the third axis Z.

The first extended electrode 25A extends inside the component body 20. The first extended electrode 25A extends in a direction parallel to the bottom surface 21B. A first end of the first extended electrode 25A is connected to the other end of the first inductor conductor 31A, which is the end opposite to the one end to which the first via conductor 32A is connected. A second end of the first extended electrode 25A, which is the end opposite to the first end, is exposed at an outer surface of the base body 26. The second end of the first extended electrode 25A is connected to the first outer electrode 24A. The first extended electrode 25A is made of a conductive material, such as silver and copper. The material of the first extended electrode 25A is the same as that of the inductor wire 30.

The second extended electrode 25B extends inside the component body 20. The second extended electrode 25B extends in a direction parallel to the bottom surface 21B. A first end of the second extended electrode 25B is connected to the other end of the sixth inductor conductor 31F, which is the end opposite to the one end to which the fifth via conductor 32E is connected. A second end of the second extended electrode 25B, which is the end opposite to the first end, is exposed at an outer surface of the base body 26. The second end of the second extended electrode 25B is connected to the second outer electrode 24B. The second extended electrode 25B is made of a conductive material, such as silver and copper. The material of the second extended electrode 25B is the same as that of the inductor wire 30.

The component body 20 is produced using a so-called sheet lamination method. More specifically, the component body 20 is formed by successively laminating a layer containing the insulator only, and then a layer containing the first inductor conductor 31A, the first extended electrode 25A, and the insulator, and then a layer containing the first via conductor 32A and the insulator, and so forth. Subsequently, the laminated body is baked to produce the component body 20. While the laminated body is baked, the resin contained in the base body 26 is volatilized and the glass is sintered. As a result, the base body 26 contracts slightly compared with that before baking.

### Area and Density

As illustrated in FIG. 1, the area of the bottom surface 21B is greater than the area of the top surface 21A in the component body 20. More specifically, the area of the bottom surface 21B is equal to or greater than 1.03 times of the area of the top surface 21A. Note that the difference between the area of the top surface 21A and the area of the bottom surface 21B is exaggerated in the drawings. Here, when the component body 20 is cut along a plane parallel to the bottom surface 21B at an arbitrary position, the area of the section of the component body 20 is referred to as a first sectional area. Similarly, when the component body 20 is cut along another plane parallel to the bottom surface 21B at a position closer to the bottom surface 21B from the arbitrary position, the area of the section of the component body 20 is referred to as a second sectional area. In this case, the second sectional area is equal to or greater than the first sectional area. In other words, when the component body 20 is cut along multiple planes parallel to the bottom surface 21B at positions from the top surface 21A toward the bottom surface 21B, the area of the section increases and does not decrease as the position comes closer to the bottom surface 21B.

FIG. 2 is a cross section taken by cutting the component body 20 along a plane extending normal to the bottom surface 21B and parallel to the second axis Y. In this cross-section, the side of the component body 20 positioned at the top surface 21A is referred to as a first upper base, and the side of the component body 20 positioned at the bottom surface 21B is referred to as a first lower base. In the present embodiment, the dimension LB1 of the first lower base is 1.03 times greater than the dimension UB1 of the first upper base. FIG. 3 is a cross section taken by cutting the component body 20 along a plane extending normal to the bottom surface 21B and parallel to the first axis X. In this cross-section, the side of the component body 20 positioned at the top surface 21A is referred to as a second upper base, and the side of the component body 20 positioned at the bottom surface 21B is referred to as a second lower base. In the present embodiment, the dimension LB2 of the second lower base is 1.03 times greater than the dimension UB2 of the second upper base. Accordingly, in the present embodiment, the area of the bottom surface 21B is approximately 1.06 times greater than the area of the top surface 21A.

As illustrated in FIG. 2, an imaginary line segment LS is drawn from an arbitrary position on the bottom surface 21B to the top surface 21A in a direction normal to the bottom surface 21B. A point on the imaginary line segment LS at one tenth of the dimension of the imaginary line segment LS from the end at the bottom surface 21B is referred to as a specified point SP. A portion of the base body 26 from the top surface 21A to the specified point SP is referred to as a top-side portion 26A, and a portion of the base body 26 from the specified point SP to the bottom surface 21B is referred to as a bottom-side portion 26B. The content of the insulator particles in the bottom-side portion 26B is higher than the content of the insulator particles in the top-side portion 26A. As a result, the average weight density of the bottom-side portion 26B is greater than the average weight density of the top-side portion 26A. More specifically, the average weight density of the bottom-side portion 26B is equal to or greater than 1.1 times of the average weight density of the top-side portion 26A. In addition, the average weight density of the bottom-side portion 26B is equal to or less than 1.5 times of the average weight density of the top-side portion 26A. Note that the top-side portion 26A and the bottom-side portion 26B contain the same types of materials. Accordingly, the content of the insulator particles in the bottom-side portion 26B is 1.1 times or more and 1.5 times or less (i.e., from 1.1 times to 1.5 times) of the content of the insulator particles in the top-side portion 26A. Note that a clear boundary does not necessarily exist between the top-side portion 26A and the bottom-side portion 26B.

The bottom-side portion 26B does not contract readily compared with the top-side portion 26A during baking because the bottom-side portion 26B has a higher content of the insulator particles. As a result of this, the dimension LB1 of the first lower base becomes greater than the dimension UB1 of the first upper base, and the dimension LB2 of the second lower base becomes greater than the dimension UB2 of the second upper base.

The middle point of the imaginary line segment LS is referred to as a midpoint MP between the top surface 21A and the bottom surface 21B. As a result of the bottom-side portion 26B having a greater average weight density, the average weight density of a portion of the base body 26 between the midpoint MP and the bottom surface 21B is greater than the average weight density of a portion of the base body 26 between the midpoint MP and the top surface 21A.

Note that the weight density of the base body 26 at an arbitrary point can be obtained by taking a portion of the base body 26 out of the inductor component 10 at this point and by dividing the measured weight of the portion by the measured volume of the portion. The average weight density of the top-side portion 26A can be obtained by averaging results of weight density obtained, for example, at three arbitrary points in the top-side portion 26A using the above method. The same method is employed to obtain the average weight density of the bottom-side portion 26B.

### Advantageous Effects of Present Embodiment

(1) According to the above embodiment, the area of the bottom surface 21B is greater than the area of the top surface 21A. The bottom surface 21B has the greater area, and the inductor component 10 is placed on the board with the bottom surface 21B facing downward, which reduces the likelihood of the inductor component 10 toppling over.
(2) In the above embodiment, the area of the bottom surface 21B is equal to or greater than 1.03 times of the area of the top surface 21A. In other words, the area of the bottom surface 21B is sufficiently large relative to the area of the top surface 21A. This ensures the advantageous effect of reducing the likelihood of the inductor component 10 toppling over even if the area of the bottom surface 21B changes more or less due to deviation occurring in the manufacturing process.
(3) In the above embodiment, the component body 20 is shaped like a truncated quadrangular pyramid. The base body 26 shaped like a truncated quadrangular pyramid can be produced, for example, by changing the content of the insulator particles layer by layer in the base body 26. Accordingly, the area of the bottom surface 21B can be made greater than the area of the top surface 21A without largely changing the manufacturing process and the manufacturing equipment.
(4) According to the above embodiment, the average weight density of the bottom-side portion 26B is greater than the average weight density of the top-side portion 26A. As a result, the center of gravity of the component body 20 is positioned closer to the bottom surface 21B from the midpoint MP. Due to the center of gravity of the component body 20 being positioned closer to the bottom surface 21B, the inductor component 10 does not topple over easily.
(5) According to the above embodiment, the average weight density of the bottom-side portion 26B is equal to or greater than 1.1 times of the average weight density of the top-side portion 26A. Accordingly, the average weight density of the bottom-side portion 26B is sufficiently greater than that of the top-side portion 26A, which can bring the center of gravity of the component body 20 closer to the bottom surface 21B.
(6) According to the above embodiment, the average weight density of the bottom-side portion 26B is equal to or smaller than 1.5 times of the average weight density of the top-side portion 26A. Accordingly, the inductor component 10 providing the advantageous effect described in (1) above can be produced simply by performing a step of changing the content of the insulator particles of the bottom-side portion 26B and of the top-side portion 26A without largely changing the manufacturing process and the manufacturing equipment.
(7) In the above embodiment, the content of the insulator particles in the bottom-side portion 26B is 1.1 times or more and 1.5 times or less (i.e., from 1.1 times to 1.5 times) of the content of the insulator particles in the top-side portion 26A. If the content of the insulator particles in the bottom-side portion 26B is greater than 1.5 times, the difference in contraction between the bottom-side portion 26B and the top-side portion 26A becomes too great when the base body 26 is baked, which may cause cracks or the like. According to the above embodiment, the likelihood of the inductor component 10 toppling over can be reduced while the occurrence of cracks or the like due to the difference in contraction of portions of the base body 26 can be reduced.
(8) According to the above embodiment, the top-side portion 26A of the base body 26 is made of the same materials as those of the bottom-side portion 26B. This eliminates the necessity of providing different types of materials in manufacturing the inductor component 10. Moreover, the inductor component 10 can be produced easily by simply changing the content of the insulator particles of the insulator contained in each of the top-side portion 26A and the bottom-side portion 26B.
(9) According to the above embodiment, the inductor wire 30 includes multiple inductor conductors that extend parallel to the bottom surface 21B and are arrayed in the direction normal to the bottom surface 21B. The inductor wire 30 also includes the first to fifth via conductors 32A to 32E that connect the first to sixth inductor conductors 31A to 31F to each other, the first to sixth inductor conductors 31A to 31F being disposed adjacently in the direction normal to the bottom surface 21B. In other words, the component body 20 is produced using a so-called sheet lamination method. Accordingly, in the process of manufacturing the inductor component 10, the areas of the top surface 21A and the bottom surface 21B can be changed or the average weight density of the top-side portion 26A and the bottom-side portion 26B of the base body 26 can be changed simply by changing the content of the insulator particles of the insulator layer by layer.

### Modification Examples

The above embodiment and the modification examples described below can be combined with one another insofar as the combination does not pose a technical contradiction.

The shape of the component body 20 is not limited to the truncated quadrangular pyramid insofar as the second sectional area is equal to or greater than the first sectional area. For example, the surfaces of the truncated quadrangular pyramid can be curved. When a cross section is taken by cutting the component body 20 along a plane extending normal to the bottom surface 21B and parallel to the second axis Y or parallel to the first axis X, the cross section is not necessarily shaped like a trapezoid. In the case of the surfaces of the truncated quadrangular pyramid being curved, the surfaces may be concave surfaces or may be convex surfaces. When the component body 20 is cut along multiple planes parallel to the bottom surface 21B at positions from the top surface 21A toward the bottom surface 21B, the area of the section can increase stepwise instead of increasing gradually. The shapes of the top surface 21A and the bottom surface 21B are not limited to rectangles.

The shapes of the first principal surface 22A, the second principal surface 22B, the first end surface 23A, and the second end surface 23B are not limited to trapezoids. For example, only the first principal surface 22A and the second principal surface 22B may be shaped like trapezoids, while the first end surface 23A and the second end surface 23B may be shaped like rectangles.

The material of the first outer electrode 24A, the second outer electrode 24B, the first extended electrode 25A, and the second extended electrode 25B is not limited to what has been described in the above embodiment. Note that the material of these electrodes is preferably a metal of which the necking temperature is lower than those of the materials of the base body 26.

The first outer electrode 24A and the second outer electrode 24B may be, for example, L-shaped electrodes. In this case, for example, the first outer electrode 24A is a laminated electrode formed so as to extend from the bottom surface 21B to the first end surface 23A.

A nickel layer, a tin layer, or a gold layer can be laminated on the surface of the first outer electrode 24A and on the surface of the second outer electrode 24B. The method of laminating another layer on the surfaces of the first outer electrode 24A and the second outer electrode 24B is not specifically limited here. For example, plating can be used for this purpose.

The material of the first extended electrode 25A and the second extended electrode 25B is not limited to the same material as that of the first to sixth inductor conductors 31A to 31F.

The materials of the base body 26 are not limited to what has been described in the above embodiment. Moreover, a portion of the base body 26 includes an insulator made of materials different from those of other portions. The base body 26 is made of sintered glass containing a crystalline filler that serves as the insulator particles.

The structure of the inductor wire 30 is not limited to what has been described in the above embodiment. Insofar as the inductor wire 30 extends inside the component body 20, the shape, length, width, or the like, of the inductor wire 30 can be changed appropriately in accordance with required characteristics. In the above embodiment, the inductor wire 30 extends spirally around the axis extending parallel to the third axis Z. The inductor wire 30, however, can extend spirally around an axis extending parallel to the first axis X or to the second axis Y

The area of the bottom surface 21B can be less than 1.03 times of the area of the top surface 21A insofar as the area of the bottom surface 21B is greater than the area of the top surface 21A.

The average weight density of the bottom-side portion 26B can be less than 1.1 times of the average weight density of the top-side portion 26A. The average weight density of the bottom-side portion 26B can be equal to the average weight density of the top-side portion 26A. In other words, the density of the base body 26 can be entirely uniform. It is preferable, however, that the average weight density of the portion of the base body 26 between the midpoint MP and the bottom surface 21B be greater than the average weight density of the portion of the base body 26 between the midpoint MP and the top surface 21A, from the viewpoint that the center of gravity of the component body 20 is brought closer to the bottom surface 21B from the midpoint MP.

The average weight density of the bottom-side portion 26B can be greater than 1.5 times of the average weight density of the top-side portion 26A. The content of the insulator particles in the bottom-side portion 26B can be greater than 1.5 times of the content of the insulator particles in the top-side portion 26A.

The material of the top-side portion 26A does not need to be the same as that of the bottom-side portion 26B. Even if the material is different between the top-side portion 26A and the bottom-side portion 26B, it is easier to reduce the likelihood of the inductor component 10 toppling over if the bottom surface 21B has an area larger than that of the top surface 21A.

In the above embodiment, the area of the bottom surface 21B is caused to be greater than the area of the top surface 21A due to the difference in the content of the insulator particles between the bottom-side portion 26B and the top-side portion 26A. However, the method of changing the areas of the bottom surface 21B and the top surface 21A is not limited to this. For example, when the component body 20 is produced using the sheet lamination method, the area of each layer can be made gradually smaller while the lamination proceeds from the bottom surface 21B toward the top surface 21A. Alternatively, when a block containing multiple component bodies 20 is separated into individual ones, the block can be cut in a direction inclined from the vertical direction so as to cause the area of the bottom surface 21B to become greater than the area of the top surface 21A.

The method of manufacturing the component body 20 is not limited to the sheet lamination method. For example, a printing and lamination method can be employed. As a variation of the sheet lamination method, sheets on which the inductor conductors or the extended electrodes are printed are laminated on an insulator sheet, and the laminated sheets are pressure-bonded together to produce the component body 20.

The average weight density of the top-side portion 26A or the bottom-side portion 26B of the base body 26 can be obtained differently if it is difficult to take a portion of the base body 26 out of the inductor component 10. For example, pieces having the same compositions as those of the top-side portion 26A and the bottom-side portion 26B may be prepared, and the weight and the volume of each piece may be measured to obtain the corresponding average weight density. The same method may be employed to obtain the average weight density of a portion of the base body 26 at an arbitrary point.

### Supplementary Note

Technical ideas derived from the above embodiment and modification examples are summarized as follows.
[1] An inductor component includes i) a base body made of an insulator, ii) an inductor wire extending inside the base body, iii) extended electrodes connected to the inductor wire, each one of the extended electrodes having a portion exposed to outside of the base body, and iv) outer electrodes connected to respective ones of the extended electrodes. In the inductor component, the base body, the inductor wire, and the extended electrodes form a component body together. The component body has a flat bottom surface and a top surface facing oppositely to the bottom surface. An area of the bottom surface is greater than an area of the top surface. When a first sectional area is defined as an area of a section of the component body that is taken along a plane parallel to the bottom surface at an arbitrary position and when a second sectional area is defined as an area of another section of the component body that is taken along another plane parallel to the bottom surface at a position closer to the bottom surface from the arbitrary position, the second sectional area is equal to or greater than the first sectional area.
[2] In the inductor component described in [1] above, the area of the bottom surface may be equal to or greater than 1.03 times of the area of the top surface.
[3] In the inductor component described in [1] or [2] above, the component body may be shaped like a truncated quadrangular pyramid.
[4] In the inductor component described in any one of [1] to [3] above, in a direction normal to the bottom surface, an average weight density of a portion of the base body from the bottom surface to a midpoint between the bottom surface and the top surface may be greater than an average weight density of a portion of the base body from the midpoint to the top surface.
[5] In the inductor component described in any one of [1] to [4] above, when in a direction normal to the bottom surface, a specified point is defined as a point of one tenth of a dimension of the component body from the bottom surface, an average weight density of a portion of the base body from the bottom surface to the specified point may be greater than an average weight density of a portion of the base body from the specified point to the top surface.
[6] In the inductor component described in [5] above, the average weight density of the portion of the base body from the bottom surface to the specified point may be equal to or greater than 1.1 times of the average weight density of the portion of the base body from the specified point to the top surface.
[7] In the inductor component described in [5] or [6] above, the portion of the base body from the bottom surface to the specified point may be made of a same material as that of the portion of the base body from the specified point to the top surface.
[8] In the inductor component described in any one of [1] to [7] above, the inductor wire may include multiple inductor conductors that extend parallel to the bottom surface and are arrayed in a direction normal to the bottom surface and may also include via conductors that connect adjacent ones of the inductor conductors arrayed in the direction normal to the bottom surface.

What is claimed is:

1. An inductor component comprising:
a base body including an insulator;
an inductor wire extending inside the base body;
extended electrodes connected to the inductor wire, each one of the extended electrodes having a portion exposed to outside of the base body; and
outer electrodes connected to respective ones of the extended electrodes, wherein
the base body, the inductor wire, and the extended electrodes configure a component body together,
the component body has a flat bottom surface and a top surface facing oppositely to the bottom surface,
an area of the bottom surface is greater than an area of the top surface, and
when a first sectional area is defined as an area of a section of the component body that is taken along a plane parallel to the bottom surface at an arbitrary position, and when a second sectional area is defined as an area of another section of the component body that is taken along another plane parallel to the bottom surface at a position closer to the bottom surface from the arbitrary position, the second sectional area is equal to or greater than the first sectional area.

2. The inductor component according to claim 1, wherein
the area of the bottom surface is equal to or greater than 1.03 times of the area of the top surface.

3. The inductor component according to claim 1, wherein
the component body has a truncated quadrangular pyramid shape.

4. The inductor component according to claim 1, wherein
in a direction normal to the bottom surface, an average weight density of a portion of the base body from the bottom surface to a midpoint between the bottom surface and the top surface is greater than an average weight density of a portion of the base body from the midpoint to the top surface.

5. The inductor component according to claim 1, wherein
when in a direction normal to the bottom surface, a specified point is defined as a point of one tenth of a dimension of the component body from the bottom surface, an average weight density of a portion of the base body from the bottom surface to the specified point is greater than an average weight density of a portion of the base body from the specified point to the top surface.

6. The inductor component according to claim 5, wherein
the average weight density of the portion of the base body from the bottom surface to the specified point is equal to or greater than 1.1 times of the average weight density of the portion of the base body from the specified point to the top surface.

7. The inductor component according to claim 5, wherein
the portion of the base body from the bottom surface to the specified point is made of a same material as that of the portion of the base body from the specified point to the top surface.

8. The inductor component according to claim 1, wherein
the inductor wire includes
multiple inductor conductors that extend parallel to the bottom surface and are arrayed in a direction normal to the bottom surface, and
via conductors that connect adjacent ones of the inductor conductors arrayed in the direction normal to the bottom surface.

9. The inductor component according to claim 6, wherein
the portion of the base body from the bottom surface to the specified point is made of a same material as that of the portion of the base body from the specified point to the top surface.
